(19) United States
(12) Patent Application Publication
(10) Pub. No.: US 2021/0406428 A1
(43) Pub. Date: Dec. 30, 2021

(54) Structural Static Strength Design Method Based on Strength Field

(71) Applicant: UNIVERSITY OF SHANGHAI FOR SCIENCE AND TECHNOLOGY

(72) Inventor: XI LU, SHANGHAI (CN)

(73) Assignee: UNIVERSITY OF SHANGHAI FOR SCIENCE AND TECHNOLOGY, SHANGHAI (CN)

(21) Appl. No.: 16/962,220

(22) PCT Filed: Mar. 13, 2020
(86) PCT No.: PCT/CN2020/079174

§ 371 Date: Jul. 14, 2020

(30) Foreign Application Priority Data
Jul. 11, 2019 (CN) 201910623564.3

(51) Int. Cl. G06F 30/23

(52) U.S. Cl. CPC G06F 30/23; G06F 2111/10

(57) ABSTRACT

The invention provides a structural static strength design method based on the strength field, aiming to solve the present phenomenon that the stress field is mismatched with the overall strength in the existing structural static strength design process according to the overall strength perspective. In the present invention, the static strength of a mechanical structure and its components are treated as a field, the structural stress field and the static strength field are organically matched, and the specific method is that the ideal static strength field distribution of the dangerous cross-section of the structure is determined according to the limiting static stress amplitude distribution of the dangerous cross-section of the structure; designing an actual static strength field of the dangerous cross-section of the structure by combining materials and heat treatment; using the full field stress-strength interference model, the static strength design level of dangerous cross-section of structure can be quantitatively evaluated.

### TECHNICAL FIELD

The invention relates to the field of structural static strength design in mechanical design, and is suitable for static strength design of components made by materials such as ferrous metals and non-ferrous metals.

### BACKGROUND OF THE INVENTION

Existing static strength designs of mechanical structures and components treats the static strength of the mechanical structures and components as a whole. Therefore, existing methods consider static strength of mechanical structures and components to be uniform inside and outside and have no difference. This contradicts the fact that mechanical structures and components can be changed by surface heat treatment and work hardening to improve surface strength and hardness per se. Static load amplitude distribution of a dangerous cross-section of structures and components in a full field can be precisely solved by material mechanics or a finite element method based on a concept that stress of a structure is a mixture of field and locality. Not only structures and components are subjected to simple tensile and compressive static loads, but also stress amplitudes at different positions of a dangerous cross-section of the structures are different. Existing static strength designs only consider relationship between the maximum stress amplitude of a dangerous cross-section and overall static strength, and compare the maximum stress of a dangerous point with overall strength. Therefore, existing design methods of mechanical structures and components based on overall strength can neither prevent local strength of a dangerous cross-section from being excess, nor further provide quantitative matching of a material, heat treatment and residual compressive stress that affect static strength of a dangerous cross-section, and lack of theoretical and technical basis for design-manufacture quantitative matching. In view of the mismatch between a stress field and overall strength in existing structural static strength design processes based on the overall strength perspective, the present invention proposes a concept of strength field to realize a design of structural static strength based on a strength field, in which a maximum static stress amplitude under an extreme load and its stress distribution in a gradient direction are converted into distribution of an ideal static strength field, and then, targeting the ideal static strength field, quantitative matching of a material, heat treatment of a dangerous cross-section is performed to implement a static strength design.

### SUMMARY OF THE INVENTION

A technical problem to be solved by the present invention: the mismatch between the stress field and the overall strength in the static strength design of mechanical structures and components based on the overall strength perspective.

In order to solve the technical problem, technical solutions of the present invention provide a structural static strength design method based on a strength field, wherein the static strength of a mechanical structure and a component are treated as a field, and the structural stress field and the static strength field are organically matched, including the following steps:

Step 1, Determining the most dangerous static load limit that may occur during the use of the structure to be designed for static strength. Under this static load limit, calculate the maximum static stress at the dangerous cross-section of the structure and the stress distribution in the direction of the static stress gradient;

Step 2, Determining the ideal static strength field distribution of the structure according to the maximum static stress and the gradient direction distribution thereof, and designing the ideal static strength distribution of the mechanical structure and components, wherein the static strength distribution at any point on the dangerous cross-section of the structure is not excess and meets the strength requirement, and according to a theory of stress-strength interference, designing ideal strength at any point of the dangerous cross-section of the structure as a static stress amplitude multiplied by a safety factor at that point;

Step 3, Taking the ideal static strength distribution of the dangerous cross-section as a target, matching materials and heat treatment of the structure, wherein the actual static strength distribution determined by the materials and the heat treatment is consistent with the ideal static strength distribution as much as possible;

Step 4, Putting the maximum static stress and static stress gradient distribution, the ideal static strength and the actual static strength distribution of the structure in the same coordinate system, applying a full-field stress-strength interference model to carry out full-field quantitative evaluation on the design of the static strength of the dangerous cross-section, calculating the ratio of the actual static strength of any point to the limit static stress and the ideal static strength of the point, wherein the larger the ratio is, the larger the excess strength of the point is; the surface and core strengths were quantitatively evaluated when tangent on the inside.

Preferably, in step 1, the maximum static stress and static stress gradient direction stress distribution at the dangerous cross-section of the structure are calculated using material mechanics or finite element methods.

Preferably, in the step 1, under a simple load, the maximum static stress and the static stress gradient direction stress distribution are the surface highest stress at the dangerous cross-section of the structure and the distribution of the stress at the position along the depth.

Preferably, in step 2, the ideal intensity field is scaled up in proportion to the maximum static stress and static stress gradient direction distributions.

Preferably, in the step 2, the ideal static strength distribution on the dangerous cross-section of the structure does not have excess strength, and the strength utilization rate is maximized.

Preferably, step 3 comprises the following steps:

By utilizing the conversion relation between hardness and strength, the lowest and highest hardness distribution curves of the end quenching of the material, matching and adjusting the material and heat treatment, the designed actual static strength distribution and the ideal static strength distribution are intersected on the surface or tangent in the interior on the premise of avoiding large-range static strength excess on the surface, the subsurface and the core.

Preferably, in the step 4, if the strength excess of the secondary surface and the core part is too large, optimizing by reducing the depth of a heat treatment hardening layer or adopting a hollow structure; if the surface and core strength excess is too great, a material with a lower carbon content or a hollow structure is used.

Compared with traditional methods for designing fatigue strength based on overall strength, the present invention can actively carry out local strength matching according to materials, heat treatment and the like, so as to solve a problem of excessive local static strength caused by mismatching with local stress caused by original design according to the overall strength perspective, and realizes static strength design-manufacturing quantitative matching of mechanical structures and components.

### BRIEF DESCRIPTION OF THE DRAWINGS

FIG. 1 is a solid axis size diagram, in FIG. 1, Φ1=28.5 mm, Φ2=26.5 mm, Φ3=29.2 mm, Φ4=30.5 mm, Φ5=26.6 mm, Φ6=27.1 mm, L=468 mm;

FIG. 2 is a flow chart of an implementation of the present invention;

FIG. 3 shows the stress distribution of the dangerous cross-section;

FIG. 4 shows the critical section torsional stress and ideal static strength field distribution;

FIG. 5 is an end-quench curve of the material of the present invention;

FIG. 6 shows the actual static strength distribution design of the present invention;

FIG. 7 is a full field evaluation of the structural static strength.

### DETAILED DESCRIPTION OF THE EMBODIMENTS

The present invention will be further described below with reference to the drawings. It should be understood that these embodiments are only used to illustrate the present invention, but not for the limitation of the scope of the present invention. In addition, it should be understood that, after reading the teaching contents of the present invention, those skilled in the art can make various variations or modifications to the present invention, and these equivalent forms also fall within the scope defined by the appended claims of the present application.

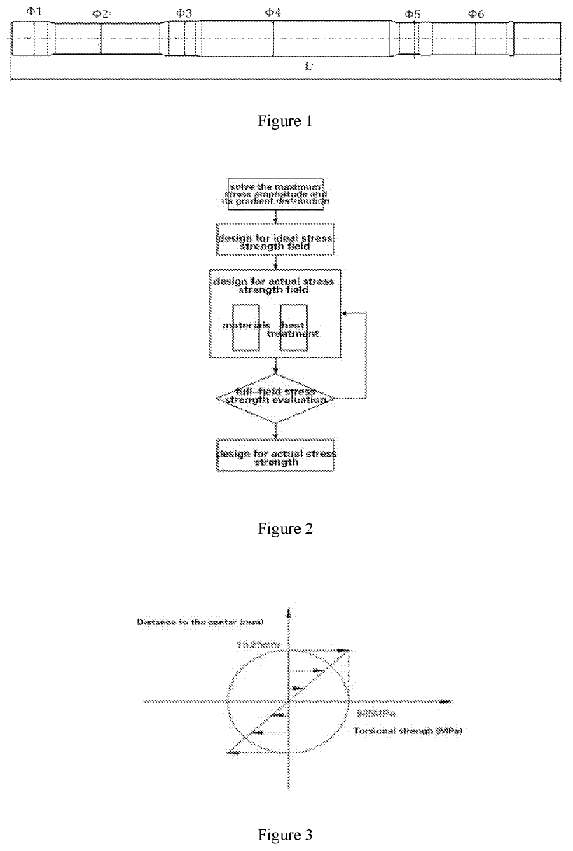

Taking the torsion of a solid shaft under torsion load as an example, the shaft is made of UC2 steel, heat treatment is surface medium frequency quenching, the surface hardness is 55-62 HRC, the depth of a hardened layer with the hardness being 500 HV is 4.5-8 mm, the core hardness is ≤30 HRC, and the size of the solid shaft is shown in FIG. 1. The structural static strength design method based on the strength field provided by the invention comprises the following steps:

1) Determining of Maximum Static Stress and its Gradient Distribution Under Static Load Limit.

The maximum static stress and its stress distribution in the gradient direction at the dangerous cross-section of the structure are calculated by using material mechanics or finite element method under the static load limit which may appear most dangerous during the use of the structure. Under a simple load, the maximum static stress and its gradient direction stress distribution are the surface highest stress at the dangerous cross-section of the structure and the structure and the distribution of the stress along the depth.

For present embodiment, the most dangerous static torsional load limit is 3600 Nm, and by applying a material mechanics method, for the dangerous cross-section of the embodiment, at the outer surface diameter 26.5 mm with the smallest torsional modulus (i.e. the smallest diameter), the highest stress is calculated as shown in formula (1):

$${τ}_{max} = \frac{T}{{W}_{t}} = \frac{3600}{\frac{π \cdot {( 26.5 \times {10}^{- 3} )}^{3}}{16}} = 985 MPa \qquad ( 1 )$$

In formula (1), Tis the torque in Nm; wt is the torsional section coefficient in m³.

The maximum static stress gradient direction is that the outer surface of the dangerous cross-section points to the axis, and the stress of any point on the dangerous cross-section is calculated as shown in formula (2):

$${τ}_{y} = \frac{T y}{{I}_{p}} = \frac{3600 • y}{\frac{π \cdot {( 26.5 \times {10}^{- 3} )}^{4}}{32}} = 74 yMPa B \qquad ( 2 )$$

In formula (2), τ_{y} is the stress at a point on the cross section at a distance of y from the axis; τ_{y} is the torque of a point on the cross section with the distance from the axis being y, and the unit is Nm; I_{P} is the cross-sectional polar moment of inertia in m⁴.

The calculated stress gradient profile for the critical section of this embodiment is shown in FIG. 3.

2) According to the Maximum Static Stress and its Gradient Distribution, the Ideal Static Strength Distribution of Dangerous Cross-Section is Designed.

According to the maximum static stress and the gradient direction distribution of the maximum static stress under the static load limit in the using process of the structure, the ideal static strength field distribution of the structure can be determined, the ideal strength field is amplified in proportion to the maximum static stress and the gradient direction distribution of the maximum static stress, and according to the stress-strength interference theory, the ideal strength of any point of the dangerous cross-section of the mechanical structure and components is designed to be the stress of the point multiplied by a safety coefficient. The ideal static strength distribution on the dangerous cross-section of mechanical structure and components does not have excess strength, and the utilization rate of strength reaches the maximum.

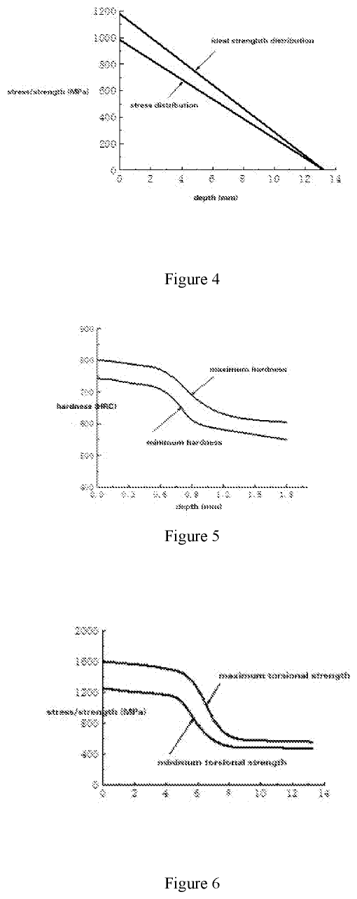

In this embodiment, the ideal strength design is such that the ideal strength at any point in the critical section of the structure is greater than the ultimate stress at that point, and the ratio of the ideal strength to the ultimate stress is a constant, which is a safety factor that is related to loading, material properties, etc. The safety factor for the static strength design in this example is 1.2, and the ideal torsional strength field distribution for the overall strength is shown in FIG. 4, which also shows the ultimate stress distribution.

3) Taking the Ideal Static Strength Field as the Target and Design the Actual Static Strength Field Distribution Based on Material and Heat Treatment.

In order to match the ideal static strength distribution of the dangerous cross-section with the material and heat treatment of the structure, the actual static strength distribution determined by the material and heat treatment should be as consistent as possible with the ideal static strength distribution. Specifically, by utilizing the conversion relation between the hardness and the strength, the lowest and highest hardness distribution curves of the end quenching of the material, matching and adjusting the material and the heat treatment, the designed actual static strength distribution and the ideal static strength distribution are intersected on the surface or tangent in the interior on the premise of avoiding large-range static strength excess on the surface, the subsurface and the core.

In the embodiment, the material of the solid shaft is UC2 steel, the heat treatment is surface medium frequency quenching, the surface hardness is 55-62 HRC, the depth of the hardened layer with the hardness of 500 HV is 4.5-8 mm, and the core hardness is ≤30 HRC. FIG. 5 is a graph showing the depth profile of the lowest and highest end-quenched hardness of the UC2 material, and the torsional static strength distribution of the structure of this example can be obtained by applying the strength-hardness conversion relationship and the third strength theory, wherein the conversion relationship between the HRC hardness and the torsional static strength in this example is shown in formula (3):

τ=0.00816H_{d}^{2.88}+420 (3)

In formula (3), τ is the torsional strength of any point of a structural mechanical structure and a part, and the unit is MPa; H_{d} is the hardness in HRC of a mechanical structure and component at any point.

The torsional static strength along the depth profile for the critical section of the structure obtained by Equation (3) is shown in FIG. 6.

4) Applying the Full-Field Stress-Strength Interference Model to Quantitatively Evaluate the Full-Field Static Strength Design of Structures.

The maximum stress and its gradient distribution, the ideal static strength and the actual static strength distribution of the structure are shown in the same coordinate system. Using the full-field stress-strength interference model, the design of the static strength of the dangerous cross-section can be quantitatively evaluated in the full field—if the ratio of the actual static strength at any point to the ultimate stress and the ideal static strength at that point is larger, and the intensity excess at that point is larger. The optimal static strength design is that the actual static strength distribution and the ideal static strength distribution of the dangerous cross-section are intersected on the surface or tangent in the interior, and when intersected on the surface, the strength of the subsurface and the core are quantitatively evaluated; the surface and core strengths were quantitatively evaluated when tangent on the inside. If the strength excess of the secondary surface and the core part is too large, optimization can be carried out by reducing the depth of a heat treatment hardening layer or adopting a hollow structure; if the surface and core strength excess is too great, a material with a lower carbon content or a hollow structure may be used.

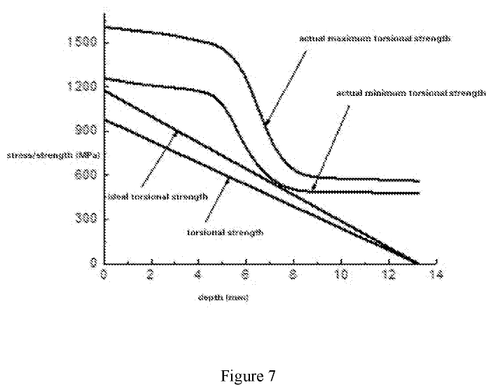

In the present embodiment, the ultimate stress distribution, the ideal intensity distribution, and the actual intensity distribution are in the same coordinate, as shown in FIG. 7, where by the static intensity design level at any point of the dangerous cross-section is evaluated. The ideal intensity and the actual intensity distribution of this example are tangent near the subsurface depth 7.3 mm, which is a dangerous point of structural design where there is no excess intensity. This example gives a quantitative evaluation of the torsional static strength design of the surface, sub-surface hardened turning point 4 mm and center point.

When the actual torsional static strength of the surface is 1287 MPa, the design ideal static strength is 1182 MPa, and the actual torsional stress is 980 MPa, the ratio of the actual torsional static strength to the torsional stress is 1.31, the ratio is larger than the design safety coefficient 1.2, and the ratio is larger than the safety coefficient 0.11, so that the strength is basically brought into full play.

When the actual torsional static strength of the sub-surface hardening turning point 4 mm is 1247 MPa, the design ideal static strength is 821 MPa, and the actual torsional stress is 684 MPa, the ratio of the actual torsional static strength to the torsional stress is 1.82, which is larger than the design safety factor 1.2 and exceeds the safety factor 0.62, but the point is determined by the heat treatment performance of the material, and the strength lightweight design is carried out by changing the depth of the hardening layer.

The actual torsional static strength of the central point is 533 MPa, the design ideal static strength and the torsional stress are both 0, the static strength excess of the point is infinite, and the torsional static strength excess of the core can be reduced by using a hollow structure if the process conditions permit.

1. The invention relates to a structural static strength design method based on a strength field, characterized in that the static strength of a mechanical structure and its components are treated as a field, and the structural stress field and the static strength field are organically matched:
Step 1, Determining the most dangerous static load limit that may occur during the use of the structure to be designed for static strength. Under this static load limit, calculate the maximum static stress at the dangerous cross-section of the structure and the stress distribution in the direction of the static stress gradient;
Step 2, Determining the ideal static strength field distribution of the structure according to the maximum static stress and the gradient direction distribution thereof, and designing the ideal static strength distribution of the mechanical structure and components, wherein the static strength distribution at any point on the dangerous cross-section of the structure is not excess and meets the strength requirement, and according to a theory of stress-strength interference, designing ideal strength at any point of the dangerous cross-section of the structure as a static stress amplitude multiplied by a safety factor at that point;
Step 3, Taking the ideal static strength distribution of the dangerous cross-section as a target, matching materials and heat treatment of the structure, wherein the actual static strength distribution determined by the materials and the heat treatment is consistent with the ideal static strength distribution as much as possible;
Step 4, Putting the maximum static stress and static stress gradient distribution, the ideal static strength and the actual static strength distribution of the structure in the same coordinate system, applying a full-field stress-strength interference model to carry out full-field quantitative evaluation on the design of the static strength of the dangerous cross-section, calculating the ratio of the actual static strength of any point to the limit static stress and the ideal static strength of the point, wherein the larger the ratio is, the larger the excess strength of the point is; the surface and core strengths were quantitatively evaluated when tangent on the inside.

2. The structural static strength design method based on strength field according to claim 1, wherein, in step 1, the maximum static stress and static stress gradient direction stress distribution at the dangerous cross-section of the structure are calculated by using material mechanics or finite element method.

3. The structural static strength design method based on strength field according to claim 1, characterized in that in step 1, under simple load, the maximum static stress and the static stress gradient direction stress distribution are the surface highest stress at the dangerous cross-section of the structure and the distribution of the stress along the depth thereof.

4. The structural static strength design method based on strength field according to claim 1, wherein, in step 2, the ideal intensity field is amplified in proportion to the maximum static stress and the static stress gradient direction distribution.

5. The structural static strength design method based on strength field according to claim 1, wherein, in step 2, the ideal static strength distribution on the dangerous cross-section of the structure has no strength excess, and the strength utilization rate is maximized.

6. The structural static strength design method based on strength field according to claim 1, wherein step 3 comprises the following steps:
By utilizing the conversion relation between hardness and strength, the lowest and highest hardness distribution curves of the end quenching of the material, matching and adjusting the material and heat treatment, the designed actual static strength distribution and the ideal static strength distribution are intersected on the surface or tangent in the interior on the premise of avoiding large-range static strength excess on the surface, the subsurface and the core.

7. The structural static strength design method based on strength field according to claim 1, wherein in step 4, if the excess of the strength of the sub-surface and the core is too much, optimization is performed by reducing the depth of the heat treatment hardened layer or using a hollow structure; if the surface and core strength excess is too much, a material with a lower carbon content or a hollow structure is used.
